(19) United States
(12) Patent Application Publication
(10) Pub. No.: US 2026/0109216 A1
(43) Pub. Date: Apr. 23, 2026

(54) INTEGRATED COOLANT MODULE

(71) Applicant: Hanon Systems, Daejeon (KR)

(72) Inventors: Jungbum CHOI, Daejeon (KR); Gwang Ok KO, Daejeon (KR); Seong Woo JEONG, Daejeon (KR)

(73) Assignee: Hanon Systems, Daejeon (KR)

(21) Appl. No.: 19/108,709

(22) PCT Filed: Jul. 11, 2023
(86) PCT No.: PCT/KR2023/009874

§ 371 Date: Mar. 4, 2025

(30) Foreign Application Priority Data
Sep. 15, 2022 (KR) 10-2022-0116002

(51) Int. Cl. B60K 11/04; B60L 58/26

(52) U.S. Cl. CPC B60K 11/04; B60L 58/26

(57) ABSTRACT

The present invention relates to an integrated coolant module to be applied to a vehicle cooling system and, more specifically, to an integrated coolant module which integrates a coolant control module composed of a reservoir tank, a valve, and a pump, and may thus optimize in-vehicle packages and assembly man-hours.

### TECHNICAL FIELD

The present invention relates to an integrated coolant module applied to a vehicle cooling system, and more particularly, to an integrated coolant module which integrates a coolant control module composed of a reservoir tank, a valve, and a pump, and may thus optimize in-vehicle packages and assembly man-hours.

### BACKGROUND ART

An electric vehicle or a hybrid vehicle may be equipped with a power electronics PE component (e.g., motor) including a motor, an inverter, and an onboard charger (OBC), and also equipped with a battery to provide power to the PE component.

The PE component or the battery may generate heat during its operation, and may thus be necessarily required to be cooled to protect the component and ensure its durability. For this purpose, the electric vehicle or the hybrid vehicle may be equipped with a water-cooled PE cooling system for cooling the PE component and a water-cooled battery cooling system for cooling the battery.

The PE component and the battery may have different temperature ranges in their main operating regions, that is, the PE component may be operated at a relatively higher temperature than the battery, and the PE component and the battery may thus require separate cooling systems. Accordingly, the PE component may be equipped with a PE cooling circuit for cooling by circulating a coolant, and the battery may be equipped with a battery cooling circuit for cooling by circulating the coolant. The PE component or the battery may further be equipped with a radiator circulation line through which the coolant is cooled by passing through a radiator.

FIG. 1 is a view showing a cooling system of a conventional electric vehicle, and as shown in this drawing, in order to operate a separate cooling circuit, each cooling circuit may include a separate reservoir tank R1 or R2. In this way, the conventional electric vehicle may be equipped with two reservoir tanks R1 and R2 used for the respective cooling circuits, which may result in difficulty in their installation within a narrow engine room, and increased manufacturing costs due to the increased components. In addition, this problem may result in inconvenience because the increased components lead to a weight increase, productivity is decreased due to an increased installation time for each reservoir tank, and maintenance needs to be performed separately for each cooling circuit.

Furthermore, referring back to FIG. 1, the PE cooling circuit and the battery cooling circuit may be equipped with pumps P1 and P2, respectively, while no separate pump is installed on a radiator circulation line. In addition, only two reservoir tanks R1 and R2 may be installed in the PE cooling circuit and the battery cooling circuit, respectively, while no separate reservoir is installed on the radiator circulation line. Accordingly, a coolant flow to the radiator circulation line may be hindered in a connection operation mode where the coolant passes through the radiator circulation line, and the reservoir may not be disposed in front of the radiator in the corresponding operation mode, which may lead to a potential problem of momentary coolant replenishment shortage, resulting in increased noise, decreased cooling performance, or the like.

### Related Art Document

[Patent Document] Korea Patent No. 10-1765578 (registered on Aug, 1, 2017)

### DISCLOSURE

### Technical Problem

An object of the present invention is to provide an integrated coolant module which may optimize in-vehicle packages and assembly man-hours, solve a potential problem of coolant replenishment shortage during pump operation, and prevent cooling performance degradation caused by a coolant bypass.

### Technical Solution

In one general aspect, an integrated coolant module includes: a reservoir tank for accommodating a coolant in a hollow internal space; and a coolant control module including at least one valve and at least one pump and coupled to one side of the reservoir tank, wherein the coolant discharged from the reservoir tank is introduced into the coolant control module, and re-introduced into the reservoir tank after being circulated to the outside through the coolant control module, and the reservoir tank is partitioned into a plurality of spaces, the plurality of spaces communicating with the at least one valve, and disposed upstream of the valve in a coolant flow.

The internal space of the reservoir tank may include a first space, a second space, and a third space, partitioned from one another.

The coolant control module may be formed as a structure in which a first pump and a second pump are coupled to the valve, the coolant of the first space may be introduced into the valve and circulated to the outside through the first pump from the valve, the coolant of the second space may be introduced into the valve and circulated to the outside through the second pump from the valve, and the coolant of the third space may be introduced into the valve and circulated to the outside through the valve.

Each of the first to third spaces may be equipped with a coolant inlet for introducing the coolant and a coolant outlet for discharging the coolant, and each of the coolant outlet of the first space, the coolant outlet of the second space, and the coolant outlet of the third space may be directly connected to the valve.

Each of the valve, the first pump, and the second pump may be equipped with the coolant outlet through which the coolant is discharged.

The internal space of the reservoir tank may be equipped with a separation bulkhead partitioning the first space, the second space, and the third space from one another, and the separation bulkhead may branch in three directions from an intersection point at which the first space, the second space, and the third space meet one another.

A single coolant inlet may be disposed on the top of the reservoir tank, and the single coolant inlet may be disposed vertically above the intersection point of the separation bulkhead.

An upper part of the separation bulkhead may be formed as a perforated structure, thus allowing the first space, the second space, and the third space to communicate with one another through the perforated upper u part of the separation bulkhead.

A surrounding bulkhead surrounding the intersection point of the separation bulkhead may be disposed around the intersection point, and the surrounding bulkhead may have a perforated part perforated through each of the first space, the second space, and the third space.

If the separation bulkhead between the first space and the second space is referred to as a first separation bulkhead, and the separation bulkhead partitioning the third space is referred to as a second separation bulkhead, an upper part of the first separation bulkhead may be formed as a perforated structure, thus allowing the first space and the second space to communicate with each other through the perforated upper part of the first separation bulkhead, and an upper part of the second separation bulkhead may be closed, thus forming the third space as an independent space separated from the first space or the second space.

The surrounding bulkhead surrounding the intersection point of the separation bulkhead may be disposed near the first space and the second space around the intersection point, and the surrounding bulkhead may include perforated parts perforated through the first space and the second space, respectively.

The separation bulkhead may branch equiangularly in the three directions from the intersection point of the separation bulkhead.

The first space, the second space, and the third space may have the same horizontal cross-sectional area.

The first space may accommodate the coolant flowing through a power electronics (PE) cooling line, the second space may accommodate the coolant flowing through a battery cooling line, and the third space may accommodate the coolant flowing through a radiator cooling line.

At least one of the plurality of spaces may be closed so as not to communicate with the remaining spaces within the reservoir tank.

Among the plurality of spaces, the space capable of communicating with each other within the reservoir tank may be disposed on a coolant circuit including both the valve and the pump.

The coolant discharged from the space capable of communicating with each other within the reservoir tank among the plurality of spaces may flow sequentially through the valve and the pump.

The coolant that flows sequentially through the valve and the pump may cool a motor or a battery.

Among the plurality of spaces, the space not communicating with the remaining spaces within the reservoir tank may be disposed on a coolant circuit including the valve instead of the pump.

Among the plurality of spaces, the coolant discharged from the space not communicating with the remaining spaces within the reservoir tank may cool a radiator and is recovered again.

According to the present invention, the in-vehicle packages and the assembly man-hours may be optimized by integrating the reservoir tank and the coolant control module.

In addition, the problem of coolant replenishment during the pump operation may be solved by forming the plurality of spaces partitioned from each other within the reservoir tank, and providing each space as the reservoir for each cooling circuit of the cooling system.

In addition, the cooling performance degradation caused by the coolant bypass may be prevented by configuring one of the plurality of spaces independently from the other spaces or by installing the surrounding bulkhead around the coolant inlet.

### DESCRIPTION OF DRAWINGS

FIG. 1 is a view showing a cooling system of a conventional electric vehicle.

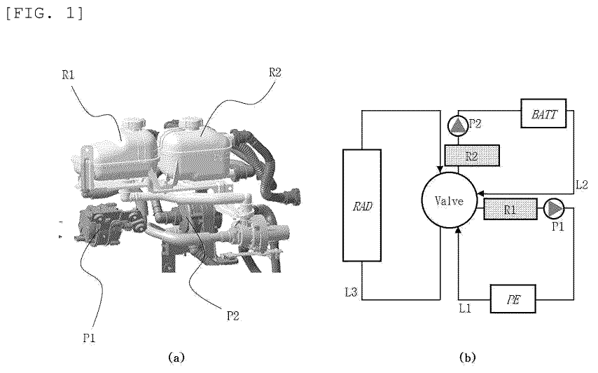

FIG. 2 is a perspective view of an integrated coolant module according to an embodiment of the present invention.

FIG. 3 is a horizontal cross-sectional view of a reservoir tank according to an embodiment of the present invention.

FIG. 4 is a view schematically showing a cooling circuit of a cooling system using the integrated coolant module of the present invention.

FIG. 5 is a horizontal cross-sectional view of a reservoir tank according to another embodiment of the present invention.

### BEST MODE

Hereinafter, the present invention is described with reference to the accompanying drawings.

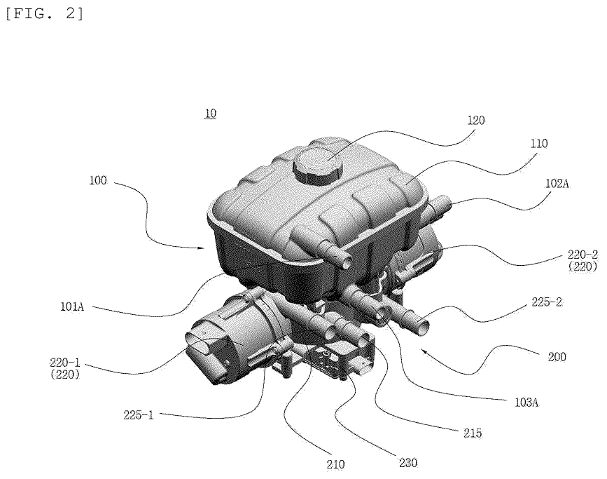

FIG. 2 is a perspective view of an integrated coolant module according to an embodiment of the present invention, and as shown in this drawing, an integrated coolant module 10 of the present invention may include a reservoir tank 100 and a coolant control module 200.

First, the description describes the reservoir tank 100.

The reservoir tank 100 may store a coolant by accommodating the coolant therein. The reservoir tank 100 may include a tank body 110 corresponding to an outer housing, a coolant inlet 120 disposed on the top of the tank body 110 and configured to inject the coolant into an internal space of the tank body 110, and a separation bulkhead 130 disposed in the internal space of the tank body 110.

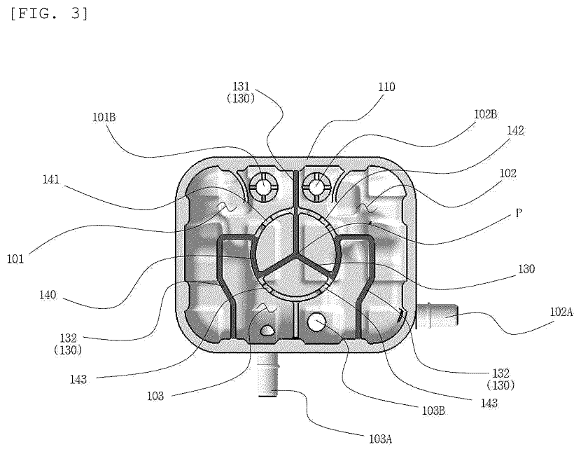

FIG. 3 is a horizontal cross-sectional view of a reservoir tank according to an embodiment of the present invention. As shown in this drawing, the internal space of the reservoir tank 100 may include a first space 101, a second space 102, and a third space 103 partitioned from one another by the separation bulkhead 130.

Referring back to FIGS. 2 and 3, the reservoir tank 100 may be equipped with the coolant inlets for introducing the coolant into each of the first to third spaces 101, 102, 103, and a coolant outlet for discharging the coolant. The drawing shows the coolant inlet of the first space 101 as a first coolant inlet 101A, the coolant outlet of the first space 101 as a first coolant outlet 101B, the coolant inlet of the second space 102 as a second coolant inlet 102A, the coolant outlet of the second space 102 as a second coolant outlet 102B, the coolant inlet of the third space 103 as a second coolant inlet 103A, and the coolant outlet of the third space 103 as a third coolant outlet 103A. Each of the coolant inlet and the coolant outlet may be formed as a through-hole structure that passes through the tank body 110 or the separation bulkhead 130, and at least a portion thereof may be formed as a pipe structure that extends therefrom by a predetermined length.

Next, the description describes the coolant control module 200.

The coolant control module 200 may correspond to a component of a cooling system in which a valve 210 and a pump 220 are modularized and integrated. That is, the coolant module 200 may include at least one valve 210 and at least one pump 220. The valve 210 may be a multidirectional automatic valve for controlling a flow path of the coolant, and the pump 220 may be a coolant pump for pressurizing and transporting the coolant. In addition, the coolant control module 200 may further include a controller 230 for controlling the valve 210 and the pump 220, and the controller 230 may be formed of a printed circuit board (PCB) equipped with electronic components and may be disposed on one side of the coolant control module 200. The coolant control module 200 may be coupled to and mounted on the bottom of the tank body 110 to thus form the integrated coolant module 10 together with the reservoir tank 100.

As shown in FIG. 2, the coolant control module 200 may include one valve 210 and two pumps 220. In detail, the coolant control module 200 may be formed as a structure in which the valve 210 is disposed in the center and a first pump 220-1 and a second pump 220-2 are coupled to both sides of the valve 210, respectively.

The valve 210 may have the coolant inlet (not shown) for introducing the coolant into the valve 210, and the coolant inlet of the valve 210 may correspond to the number of spaces in the reservoir tank described above, and be connected one-to-one with the coolant outlet of each space. In detail, the valve 210 may have three coolant inlets, and each inlet may be directly connected to the coolant outlet 101B of the first space, the coolant outlet 102B of the second space, and the coolant outlet 130B of the third space. Accordingly, the coolant in each space 101, 102, or 103 of the reservoir tank 100 may be introduced directly into the valve 210 of the coolant control module 200.

In addition, each of the valve 210, the first pump 220-1, and the second pump 220-2 may be equipped with the coolant outlet through which the coolant is discharged. The drawing shows the coolant outlet of the valve 210 as a valve coolant outlet 215, the coolant outlet of the first pump 220-1 as a first pump coolant outlet 225-1, and the coolant outlet of the second pump 220-2 as a first pump coolant outlet 225-2, respectively. Each of the valve coolant outlet and the pump coolant outlet may be formed as a through-hole structure that passes through a housing of the valve or a housing of the pump, and at least a portion thereof may be formed as a pipe structure that extends therefrom by a predetermined length.

Hereinafter, the description describes the integrated coolant module of the present invention based on the above configuration.

The integrated coolant module of the present invention is configured such that the coolant discharged from the reservoir tank 100 is introduced into the coolant control module 200, and re-introduced into the reservoir tank 100 after being circulated to the outside through the coolant control module 200. In detail, the coolant outlet 101B of the first space, the coolant outlet 102B of the second space, and the coolant outlet 103B of the third space may each be directly connected to the valve 210 of the coolant control module 200. That is, according to the integrated coolant module of the present invention, the coolant discharged from the reservoir tank may be directly introduced into the valve of the coolant control module, distributed from the valve to each cooling circuit of the cooling system to be circulated through each cooling circuit, and then be re-introduced into the reservoir tank.

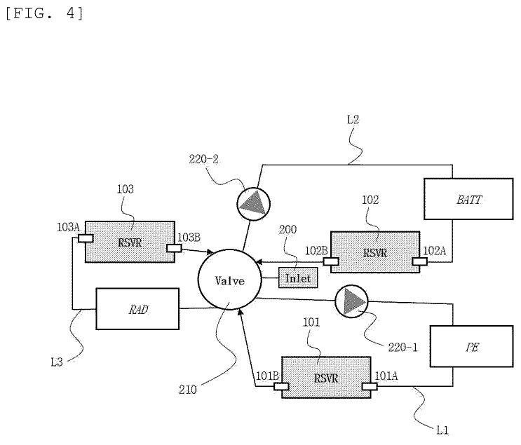

FIG. 4 is a view schematically showing the cooling circuit of the cooling system using the integrated coolant module of the present invention. As shown in this drawing, the cooling circuit of the cooling system may be classified into a PE cooling line L1 passing through a power electronics (PE) component PE, a battery cooling line L2 passing through a battery BATT, and a radiator circulation line L3 passing through a radiator RAD. In addition, the PE cooling line L1 may be equipped with the first pump 220-1, the battery cooling line L2 may be equipped with the second pump 220-2, and the radiator circulation line L3 may not be equipped with any separate pump.

The cooling system having this configuration may use the integrated coolant module of the present invention as follows. The coolant in the first space 101 of the reservoir tank 100 may be directly introduced into the valve 210 through the first coolant outlet 101B, moved from the valve 210 to the first pump 220-1, discharged from the first pump 220-1 through the first pump coolant outlet 225-1, then pressurized and transported by the first pump 220-1 to thus pass through the PE component PE, and then re-introduced into the first space 101 of the reservoir tank 100 through the first coolant inlet 101A. The coolant in the second space 102 of the reservoir tank 100 may be directly introduced into the valve 210 through the second coolant outlet 102B, moved from the valve 210 to the second pump 220-2, discharged from the second pump 220-2 through a second pump coolant outlet 225-2, then pressurized and transported by a second pump 225-2 to thus pass through the battery BATT, and then re-introduced into the second space 102 of the reservoir tank 100 through the second coolant inlet 102A. The coolant of the third space 103 of the reservoir tank 100 may be directly introduced into the valve 210 through the third coolant outlet 103B, discharged from the valve 210 through the valve coolant outlet 215 to thus pass through the radiator RAD, and then re-introduced into the third space 103 of the reservoir tank 100 through a third coolant inlet 103A.

In this way, according to the integrated coolant module of the present invention, three partitioned spaces within the reservoir tank may be provided as the reservoir for each cooling circuit of the cooling system, and the coolant discharged from each space may be introduced into the valve of the coolant control module to thus form the reservoir space for storing the coolant in front of the pump in each cooling circuit under any connection operation mode, thereby solving a potential problem of momentary coolant replenishment shortage during the pump operation.

That is, a conventional cooling system may be formed as a structure in which a coolant discharged from a reservoir tank passes through a pump to be circulated through each cooling circuit, is then introduced into a valve, and is distributed from the valve to be re-introduced into the reservoir tank. In this case, in a specific connection operation mode, for example, an operation mode where the coolant passes through a radiator, no reservoir is disposed in front of the pump on a radiator circulation line, thus causing a shortage of a coolant amount required for replenishment during pump operation, resulting in increased noise, decreased performance, or the like. However, the present invention is configured such that the reservoir tank is partitioned into three spaces to allow the coolant of each space to be supplied to each cooling circuit, and simultaneously, the coolant outlet of each space is directly connected to the valve to allow the coolant of each space to be directly introduced into the valve, thereby solving the problems such as the increased noise, the decreased performance, or the like occurring in the conventional cooling system.

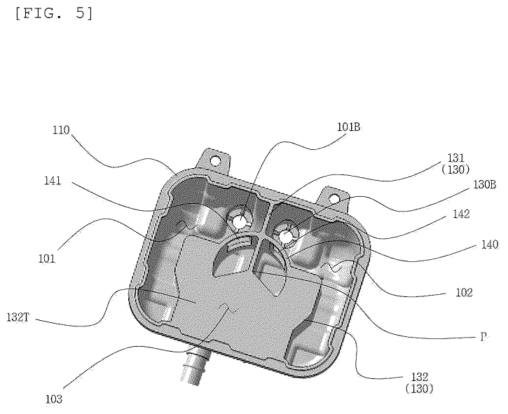

FIG. 3 is the horizontal cross-sectional view of the reservoir tank according to an embodiment of the present invention, and FIG. 5 is a horizontal cross-sectional view of a reservoir tank according to another embodiment of the present invention. The description below describes the reservoir tank according to each embodiment.

First, the description describes the reservoir tank according to an embodiment with reference to FIG. 3.

As shown in this drawing, the internal space of the reservoir tank 100 may be equipped with the separation bulkhead 130 for partitioning the first space 101, the second space 102, and the third space 103 from one another. Here, the separation bulkhead 130 may be structured to branch in three directions from an intersection point P at which the first space 101, the second space 102, and the third space 103 meet one another.

In addition, a single coolant inlet 120 may be provided, and the single coolant inlet 120 may be disposed on the top of the tank body 110 and disposed vertically above the intersection point P of the separation bulkhead 130 described above. The coolant inlet 120 may be disposed vertically above the intersection point P of the separation bulkhead 130, thus allowing the coolant injected through the coolant inlet 120 to be distributed to the first to third spaces 101, 102, and 103. That is, the present invention may have the coolant inlet disposed vertically above the intersection point of the separation bulkhead. Accordingly, even when the single coolant inlet is provided, the coolant may be injected simultaneously into each of the first to third spaces. The single coolant inlet provided in this way may improve coolant injection performance and reduce manufacturing cost of the reservoir tank.

Here, when the single coolant inlet 120 is provided and the coolant injected from the coolant inlet 120 is simultaneously distributed to each of the first to third spaces 103, the first to third spaces 101, 102, and 103 may communicate with each other near the coolant inlet 120. In detail, the upper part of the separation bulkhead 130 may be formed as a perforated structure, thus allowing the first space 101, the second space 102, and the third space 103 to communicate with one another through the perforated upper part of the separation bulkhead 130. For example, the separation bulkhead 130 may have a predetermined height upward from the bottom of the tank body 110, thus providing a predetermined distance between the top of the separation bulkhead 130 and an upper surface of the tank body 110. In addition, the first to third spaces 101, 102, and 103 may communicate with one another through the perforated upper part of the separation bulkhead 130, i.e., upper part of the separation bulkhead 130 having the predetermined height.

Meanwhile, the coolants respectively accommodated in the first to third spaces 101, 102, and 103 may have different cooling circuits for circulating the coolant and thus have different temperature distributions. Referring back to FIG. 4, the coolant of the first space 101 may flow through the PE cooling circulation line L1 for cooling the PE component PE, the coolant of the second space 102 may flow through the battery cooling circulation line L2 for cooling the battery BATT, and the coolant of the third space 103 may flow through the radiator circulation line L3, which is cooled by the radiator RAD by being connected in series with the PE cooling circulation line L1 or the battery circulation line L2 depending on the connection operation mode of the cooling system.

Here, a temperature range of a main operating region of the PE component may be higher than that of the battery, and accordingly, a temperature of the coolant in the first space 101 that is re-introduced thereto after being circulated through the PE cooling circulation line L1 may be higher than a temperature of the coolant in the second space 102 that is re-introduced thereto after being circulated through the battery cooling circulation line L2. The radiator circulation line L3 through which the coolant of the third space 103 flows may be selectively connected to the PE cooling circulation line L1 or the battery cooling circulation line L2, and accordingly, the coolant of the third space 103 may have a different temperature distribution from that of the coolant in the first space 101 or the second space 102. As described above, the coolant of each space may have different temperature distribution, and each cooling circuit may have different main operating temperature range. Therefore, it is not desirable for the coolant of each space to be mixed with the coolant in another space.

To prevent this issue, the present invention adopts a configuration employing a surrounding bulkhead 140. Referring back to FIG. 3, as shown in this drawing, the surrounding bulkhead 140 surrounding the intersection point P of the separation bulkhead 130 may be disposed around the intersection point P. The surrounding bulkhead 140 may be formed as a cylindrical wall structure surrounding the intersection point P while being spaced apart by a predetermined distance from the intersection point P. In addition, the surrounding bulkhead 140 may have a perforated part perforated through each of the first space 101, the second space 102, and the third space 103. The drawing shows the perforated part perforated toward the first space 101 as a first perforated part 141, the perforated part perforated toward the second space 102 as a second perforated part 142, and the perforated part perforated toward the third space 103 as a third perforated part 143. One or more of the first to third perforated part 130A, 130B, and 130C may be provided, respectively. In this way, the surrounding bulkhead 140 including the perforated parts 130A, 130B, and 130C may be provided to thus prevent the coolant of each space from being bypassed into another space. In addition, the surrounding bulkhead 140 may assist in ensuring that the coolant injected through one coolant inlet 120 is distributed evenly to each space without being concentrated in one space.

Next, the description describes the reservoir tank according to another embodiment with reference to FIG. 5.

As shown in this drawing, the internal space of the reservoir tank 100 may include the separation bulkhead 130 for partitioning the first space 101, the second space 102, and the third space 103 from one another. The separation bulkhead 130 may be structured to branch in three directions from the intersection point P at which the first space 101, the second space 102, and the third space 103 meet one another, as in the previous example.

Here, in the previous example, the first to third spaces 101, 102, and 103 may each communicate with one another. On the other hand, this example differs from the previous example in that the first space 101 and the second space 102 communicate with each other, and the third space 103 is formed as an independent space separated from the first space 101 or the second space 102. In detail, if the separation bulkhead disposed between the first space 101 and the second space 102 is referred to as a first separation bulkhead 131, and the separation bulkhead for partitioning the third space 103 is referred to as a second separation bulkhead 132, an upper part of the first separation bulkhead 131 may be formed as the perforated structure, thus allowing the first space 101 and the second space 102 to communicate with each other through the perforated upper part of the separation bulkhead 131, and an upper part of the second separation bulkhead 132 may be closed, thus separating the third space 103 from the first space 101 or the second space 102. For example, both the first separation bulkhead 131 and the second separation bulkhead 132 may have a predetermined height upward from the bottom of the tank body 110, thus providing a predetermined distance between the top of each of the first separation bulkhead 131 and the second separation bulkhead 132 and the upper surface of the tank body 110. Among these bulkheads, the first space 101 and the second space 102 may communicate with each other through the perforated upper part of the first separation bulkhead 131, that is, the upper part of the first separation bulkhead 131 having the predetermined height, and the upper part of the second separation bulkhead 132 may be closed by a structure such as a top plate 132T, thus separating the third space 103 from the first space 101 and the second space 102.

This configuration may be related to the fact that the pump is not disposed on the radiator circulation line L3 through which the coolant of the third space 103 is circulated. Referring back to FIG. 4, as described above, the PE cooling line L1 and the battery cooling line L2 may be equipped with the pumps P1 and P2, respectively, while the radiator circulation line L3 may not be equipped with any separate pump. If necessary, the radiator circulation line L3 may be configured in such a way that the coolant flows through the valve to the PE cooling line L2, for example, in the specific connection operation mode. In this case, the PE cooling line L2 and the radiator circulation line L3 may be connected in series with each other, and accordingly, all the coolant passing through the PE component PE may need to be circulated to the radiator RAD.

Here, if the third space 103 communicates with the first space 101 and the second space 102, and the third space 103 is connected in parallel with the first space 101 or the second space 102, the coolant may hardly flow to the radiator circulation line L3, which is not equipped with any pump to pressurize and transport the coolant, and accordingly, most of the coolant may be bypassed to the first space 101 on the PE cooling line L1, which has a small resistance due to a first pump P1.

That is, although the coolant needs to be cooled by passing through the radiator RAD through the radiator circulation line L3, if the third space 103 communicates with the first space 101 or the second space 102, the coolant in the third space 103 may flow into another space to be re-circulated through another cooling line, which may hinder the cooling thus decreasing the cooling performance and resulting in the performance deterioration of the PE component PE or the battery BATT. The reservoir tank 100 according to this embodiment may solve the above problem by having the third space 103 formed as an independent space by separating the same from the first space 101 or the second space 102.

In addition, referring back to FIG. 5, in the reservoir tank 100 according to this embodiment, the surrounding bulkhead 140 surrounding the intersection point P of the separation bulkhead 130 may be disposed near the first space 101 and the second space 102 around the intersection points P, and the surrounding bulkhead 140 may include the perforated parts 141 and 142 perforated through the first space 101 and the second space 102, respectively.

Furthermore, as in the previous embodiment, in this embodiment, the single coolant inlet 120 is provided, and the single coolant inlet 120 may be disposed vertically above the separation bulkhead intersection point P. In the present invention, the surrounding bulkhead 140 may be provided around the single coolant inlet 120, thus allowing the coolant injected through the single coolant inlet 120 to be distributed more evenly into each space. Meanwhile, in this embodiment, the third space 103 may not be initially separated from the first space 101 or the second space 102, and the coolant bypass prevention function in the previous embodiment may not work.

Referring back to FIGS. 3 and 5, the separation bulkhead 130 for partitioning the first to third spaces 101, 102, and 103 may branch equiangularly in three directions from the intersection point P of the separation bulkhead 130 described above, and the first space 101, the second space 102, and the third space 103 may have the same horizontal cross-sectional area. The separation bulkhead 130 may branch equiangularly at the intersection point P, thus allowing the coolant injected through the coolant inlet 120 to be distributed more evenly into each space. In addition, the respective spaces may have the same horizontal cross-sectional area, thus providing the same coolant accommodation capacity. Accordingly, the respective spaces may have their highest and lowest water levels set to be the same, which may increase convenience of manufacturing and using the reservoir tank.

As described above, the integrated coolant module of the present invention may be a module of the reservoir tank, the pump, and the valve, which integrates the components of the cooling system with one another, thereby increasing packaging efficiency and optimizing assembly man-hours, and may solve the coolant replenishment shortage problem by providing the reservoir in front of the pump in any operation mode of the cooling system. In addition, the integrated coolant module may have the independent space formed by separating one space from another space or may have the surrounding bulkhead, thereby preventing the cooling performance degradation due to the coolant bypass. Furthermore, the integrated coolant module may have the single coolant inlet, thereby improving the coolant injection performance and reducing the manufacturing cost.

The embodiments of the present invention have been described hereinabove with reference to the accompanying drawings. However, it should be understood by those skilled in the art to which the present invention pertains that various modifications and alterations may be made without departing from the technical spirit or essential feature of the present invention. Therefore, it should be understood that the embodiments described hereinabove are illustrative rather than restrictive in all respects.

### DESCRIPTION OF REFERENCE NUMERALS

10: integrated coolant module
100: reservoir tank
110: tank body
120: coolant inlet
130: bulkhead
131: first bulkhead
132: second bulkhead
101: first space
102: second space
103: third space
200: coolant control module
210: valve
220: pump
220-1: first pump
220-2: second pump

1. An integrated coolant module comprising:
a reservoir tank for accommodating a coolant in a hollow internal space; and
a coolant control module including at least one valve and at least one pump and coupled to one side of the reservoir tank,
wherein the coolant discharged from the reservoir tank is introduced into the coolant control module, and re-introduced into the reservoir tank after being circulated to the outside through the coolant control module, and
the reservoir tank is partitioned into a plurality of spaces, the plurality of spaces communicating with the at least one valve, and disposed upstream of the valve in a coolant flow.

2. The module of claim 1, wherein the internal space of the reservoir tank includes a first space, a second space, and a third space, partitioned from one another.

3. The module of claim 2, wherein the coolant control module is formed as a structure in which a first pump and a second pump are coupled to the valve,
the coolant of the first space is introduced into the valve and circulated to the outside through the first pump from the valve,
the coolant of the second space is introduced into the valve and circulated to the outside through the second pump from the valve, and
the coolant of the third space is introduced into the valve and circulated to the outside through the valve.

4. The module of claim 3, wherein each of the first to third spaces is equipped with a coolant inlet for introducing the coolant and a coolant outlet for discharging the coolant, and
each of the coolant outlet of the first space, the coolant outlet of the second space, and the coolant outlet of the third space is directly connected to the valve.

5. The module of claim 3, wherein each of the valve, the first pump, and the second pump is equipped with the coolant outlet through which the coolant is discharged.

6. The module of claim 2, wherein the internal space of the reservoir tank is equipped with a separation bulkhead partitioning the first space, the second space, and the third space from one another, and
the separation bulkhead branches in three directions from an intersection point at which the first space, the second space, and the third space meet one another.

7. The module of claim 6, wherein a single coolant inlet is disposed on the top of the reservoir tank, and
the single coolant inlet is disposed vertically above the intersection point of the separation bulkhead.

8. The module of claim 7, wherein an upper part of the separation bulkhead is formed as a perforated structure, thus allowing the first space, the second space, and the third space to communicate with one another through the perforated upper part of the separation bulkhead.

9. The module of claim 8, wherein a surrounding bulkhead surrounding the intersection point of the separation bulkhead is disposed around the intersection point, and
the surrounding bulkhead has a perforated part perforated through each of the first space, the second space, and the third space.

10. The module of claim 7, wherein if the separation bulkhead between the first space and the second space is referred to as a first separation bulkhead, and the Separation bulkhead partitioning the third space is referred to as a second separation bulkhead,
an upper part of the first separation bulkhead is formed as a perforated structure, thus allowing the first space and the second space to communicate with each other through the perforated upper part of the first separation bulkhead, and
an upper part of the second separation bulkhead is closed, thus forming the third space as an independent space separated from the first space or the second space.

11. The module of claim 10, wherein the surrounding bulkhead surrounding the intersection point of the separation bulkhead is disposed near the first space and the second space around the intersection point, and
the surrounding bulkhead includes perforated parts perforated through the first space and the second space, respectively.

12. The module of claim 6, wherein the separation bulkhead branches equiangularly in the three directions from the intersection point of the separation bulkhead.

13. The module of claim 6, wherein the first space, the second space, and the third space have the same horizontal cross-sectional area.

14. The module of claim 2, wherein the first space accommodates the coolant flowing through a power electronics (PE) cooling line,
the second space accommodates the coolant flowing through a battery cooling line, and
the third space accommodates the coolant flowing through a radiator cooling line.

15. The module of claim 1, wherein at least one of the plurality of spaces is closed so as not to communicate with the remaining spaces within the reservoir tank.

16. The module of claim 15, wherein among the plurality of spaces, the space capable of communicating with each other within the reservoir tank is disposed on a coolant circuit including both the valve and the pump.

17. The module of claim 16, wherein the coolant discharged from the space capable of communicating with each other within the reservoir tank among the plurality of spaces flows sequentially through the valve and the pump.

18. The module of claim 17, wherein the coolant that flows sequentially through the valve and the pump cools a motor or a battery.

19. The module of claim 15, wherein among the plurality of spaces, the space not communicating with the remaining spaces within the reservoir tank is disposed on a coolant circuit including the valve instead of the pump.

20. The module of claim 19, wherein among the plurality of spaces, the coolant discharged from the space not communicating with the remaining spaces within the reservoir tank cools a radiator and is recovered again.
